(19) United States
(12) Patent Application Publication
(10) Pub. No.: US 2009/0092234 A1
(43) Pub. Date: Apr. 9, 2009

(54) ANSWERING VIDEO CHAT REQUESTS

(75) Inventors: Eric Paul St. Onge, San Francisco, CA (US); Elizabeth Caroline Furches, San Francisco, CA (US); Marcel MWA van Os, San Francisco, CA (US); Jean-Pierre Ciudad, San Francisco, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/868,439

(22) Filed: Oct. 5, 2007

(51) Int. Cl. H04M 11/00

(52) U.S. Cl. 379/88.13; 379/93.01

(57) ABSTRACT

Methods, systems, and computer-readable medium for providing audio-video messaging in a video chat system. In one implementation, a method is provided. The method includes receiving a video chat request from a caller, and providing a video message in response to the video chat request, where the video message is operable for playback.

### TECHNICAL FIELD

This disclosure generally relates to videoconferencing.

### BACKGROUND

Video chat systems, sometimes referred to as videoconferencing systems, allow a first user, the caller, to call one or more second users, the call recipient(s), to establish a video chat session. A second user may be unable or unwilling to accept the call from the first user, in which case the video conference is not established.

### SUMMARY

A technique, method, apparatus, and system are described to provide audio-video messaging in a video chat system. In general, in one aspect, a method is provided. The method includes receiving a video chat request from a caller, and providing a video message in response to the video chat request, where the video message is operable for playback.

Implementations can include one or more of the following features. A responsive video message can be received from the caller, where the responsive video message is operable for playback, and the responsive video message can be stored. A user interface for playing the responsive video message can be provided, and it can be indicated, in the user interface, that the responsive video message has been received. The video message can be recorded. An indication that the video chat request has been received can be provided in a user interface, and the video message can be provided in response to the video chat request after a period of time has elapsed since receiving the video chat request. The video message can be provided when no user input has been received for a period of time exceeding a threshold. User input selecting a value of a status indicator can be received, and the video message can be provided when the value of the status indicator indicates a do-not-disturb status.

In one aspect, a method is provided. The method includes sending a request for a video chat to a call recipient, receiving, in response to the request, a video message, and presenting the video message. Implementations can include the following feature. A responsive video message can be recorded, and the responsive video message can be sent to the call recipient.

Particular embodiments of the subject matter described in this specification can be implemented to realize one or more of the following advantages. Audio-video messages can be exchanged between a first user requesting a video chat and a second user without requiring concurrent interaction from both users at a same time. A user can choose to automatically present a pre-recorded audio, video, or audio-video message in response to any future video chat requests to avoid having to accept or reject the requests at time of receipt. Thus, the video chat system can be used as an always-on service without unnecessarily interrupting the user while the user is engaged in another chat session or another task. The audio-video messaging services are provided using an answering machine-type application that is familiar to most users who have used conventional telephone answering machines.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example of an architecture for video chat communications.

FIG. 2 shows a screen shot depicting an example of a video answering machine settings dialog.

FIG. 3 shows the screen shot of an example settings dialog of FIG. 2 in which a user is recording a message.

FIG. 4A is a screen shot depicting an example of a dialog for video chat communication.

FIG. 4B is a screen shot depicting an example of a video message alert.

FIG. 5 is a flow chart of an example method for recording a video answering machine message.

FIG. 6 is a flow chart of an example method for exchanging video answering machine messages.

### DETAILED DESCRIPTION

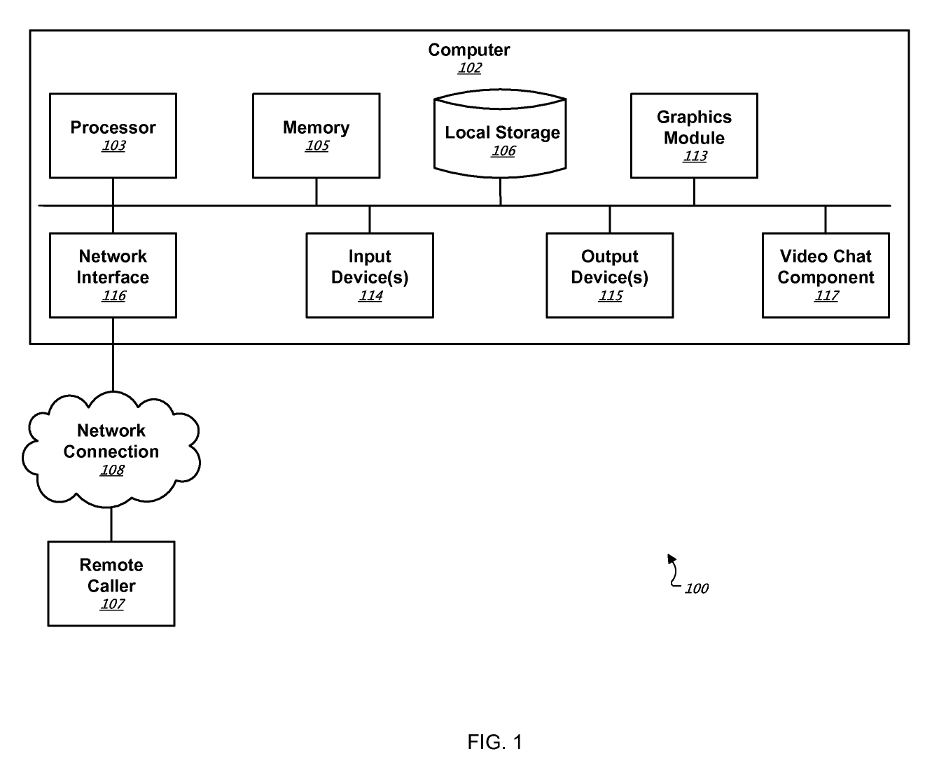

FIG. 1 is a block diagram of an architecture 100 (e.g., a hardware architecture) for recording and exchanging video answering machine messages in a video chat or videoconferencing environment. The architecture 100 includes a personal computer 102 communicatively coupled to a caller 107 (e.g., another personal computer or device) via a network interface 116 and a network 108 (e.g., local area network, wireless network, Internet, intranet, etc.). The computer 102 generally includes a processor 103, memory 105, one or more input devices 114 (e.g., keyboard, mouse, video recording device, audio recording device, etc.) and one or more output devices 115 (e.g., a display device, speaker device). A user interacts with the architecture 100 via the input and output devices 114, 115. In some implementations, the user interacts with a touch-sensitive display. Architecture 100 can include hardware, software, and combinations of the two.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that includes data and/or participates in providing instructions to a processor for execution, including without limitation, non-volatile media (e.g., optical or magnetic disks), volatile media (e.g., memory), and transmission media. Transmission media includes, without limitation, coaxial cables, copper wire, fiber optics, and computer buses. Transmission media can also take the form of acoustic, light or radio frequency waves.

While video answering machine message exchanges are described herein with respect to a personal computer 102, it should be apparent that the disclosed implementations can be incorporated in, or integrated with, any electronic device that has a user interface, including without limitation, portable and desktop computers, servers, electronics, media players, game devices, mobile phones, email devices, personal digital assistants (PDAs), embedded devices, televisions, other consumer electronic devices, etc. In addition, the caller 107, while described herein with respect to another personal computer, can also be incorporated in or integrated with any electronic device that has a user interface.

Systems, apparatuses, computer program products, and methods are provided for recording and exchanging video answering machine messages. The systems and apparatuses can be stand alone or otherwise integrated into a more comprehensive system/application. In the materials presented below, an integrated system and method for recording and exchanging video answering machine messages is disclosed by way of example. Other system configurations are possible.

The engines, methods, processes and the like that are described can themselves be an individual process or application, part of an operating system, a plug-in, an application or the like. In one implementation, the engines, methods, and processes can be implemented as one or more plug-ins that are installed and run on the personal computer 102. The plug-ins can be configured to interact with an operating system (e.g., MAC OS® X, WINDOWS XP, LINUX, etc.) or another application and to perform the various functions, as described with respect to the Figures. The systems, apparatuses, computer program products, and methods for recording and exchanging video answering machine messages can also be implemented as one or more software applications running on the computer 102. Such can be characterized as a framework or model that can be implemented on various platforms and/or networks (e.g., client/server networks, wireless networks, stand-alone computers, portable electronic devices, mobile phones, etc.), and/or embedded or bundled with one or more software applications (e.g., email, media player, browser, etc.).

The computer 102 includes a video chat component 117 that provides the user with the capability to communicate, for example with the caller 107, via video and audio exchanges. In some implementations, the video chat component 117 includes a video conferencing graphical user interface (GUI). If the user of computer 102, the call recipient, is not available to actively engage in video communications when contacted by the caller 107, the video chat component 117 can provide a response (e.g., a video answering machine message) to the caller. As used herein, the term video answering machine message refers to a message comprised of video, audio, or a combination thereof. A video answering machine message is sometimes referred to simply as a video message. In particular, a video message that is provided to a caller in response to a video chat request can be referred to as a video greeting. The video chat component 117, in some implementations, allows for the storage of pre-recorded video answering machine messages, for example within the local storage 106 or in an external storage repository.

In some implementations, the video chat component 117 also allows the caller 107 to leave a video answering machine message in response to the greeting sent to the caller 107. A video answering machine message that is provided by the caller 107 can be referred to as a responsive video message. In some implementations, an indicator within the video conferencing GUI alerts the user of computer 102 of the availability of stored video messages received from a caller.

In some implementations, video answering machine messages can be uploaded to a video chat server attached to a network connection 108 (not pictured). In this example, the video chat component 117 communicates with the video chat server to upload video answering machine messages. If a video chat request is initiated by the caller 107 while the computer 102 is not connected to the network connection 108 and/or the video chat component 117 on the computer 102 is not active, the video chat server can respond to the caller 107 with the answering machine message. In some implementations, the caller 107, in response to receiving the answering machine message, can send a responsive video message to the call recipient. The responsive video message, in some implementations, can be stored in a video mailbox within the video chat server attached to the network connection 108. In this example, when the call recipient next connects to the network connection 108 and activates the video chat component 117, some or all of the contents of the video mailbox can be downloaded or otherwise be made available to the computer 102 for viewing by the call recipient. In some implementations, video answering machine messages are accessible by means other than or in addition to the video chat component 117. For example, a call recipient could access video answering machine messages stored in a video mailbox within the video chat server through, e.g., a web site for an online application or a mobile phone application.

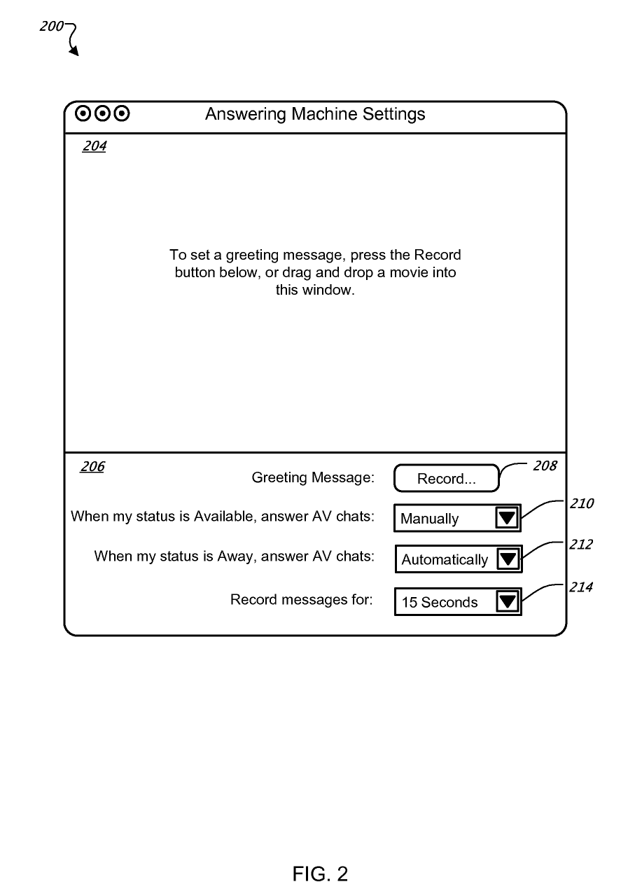

FIG. 2 shows a screen shot depicting an example of a video answering machine settings dialog 200. In the example shown, a viewing pane 204 informs the user that, to set a greeting message, the user can either press a record button 208 or drag and drop a movie into the window. In other implementations, the user can browse for and select a message from an edit menu. Pre-recorded video greetings, can, in some implementations, be provided by the video chat component 117 as default greeting selections. For example, animated greetings or musical responses can be made available as default video greetings. In some implementations, if the record button 208 is pressed, the image of the user being captured on video is displayed within the viewing pane 204. If the user drags a video into the viewing pane, in some implementations, the video begins to play to allow the user to preview the message before setting the message as the answering machine greeting.

In some implementations, the settings dialog 200 includes a control panel 206 with answering machine setting controls, 208, 210, 212, 214. The record button 208, when selected, allows the user to record a greeting message. A record time drop-down menu 214 allows the user to select the length of the responsive video message recording. This setting determines the maximum length of a recording of a responsive video message received by the user from a caller. In the example shown, the drop-down menu 214 is set to 15 seconds. In some implementations, the word “record” on the record button 208 can be replaced with the word “stop,” and the user can stop the recording when the greeting message is complete by selecting the “stop” button.

In some implementations, a set of drop-down menus 210 and 212 allow the user to select a default response depending upon the user's present status. For example, if the user's status is set to “Available,” the answering machine greeting is set to be sent manually within drop-down menu 210. The manual setting means that the greeting is not sent by default when a video chat request is received while the user is available. Instead, when a request is received, the user can provide user input indicating whether to accept the request or respond with the answering machine greeting. If the user's status is set to “Away,” the answering machine greeting is set to be sent automatically within the drop-down menu 212. In other implementations, the user can set the answering machine greeting to automatically respond when another video chat is presently underway, or when the user has been idle for a certain length of time (e.g., no user input has been received by the system for a specified period of time), or if the user does not respond to the video chat request within a certain amount of time. For example, if the user is unresponsive to the video chat request for more than 30 seconds, an answering machine greeting can be automatically sent. In some implementations, a user can select default responses by selecting, for example, a status response button (not shown), which can trigger the display of an overlay over the settings dialog 200 that allows the user to select default responses depending upon the user's present status (e.g., Available, Away, Busy, or Idle). In some implementations, the user can select different greetings to be sent depending upon the caller, the current time or date, or the caller's status. For example, one greeting can be specified for callers who are within the user's friends list, while any other callers receive a second greeting.

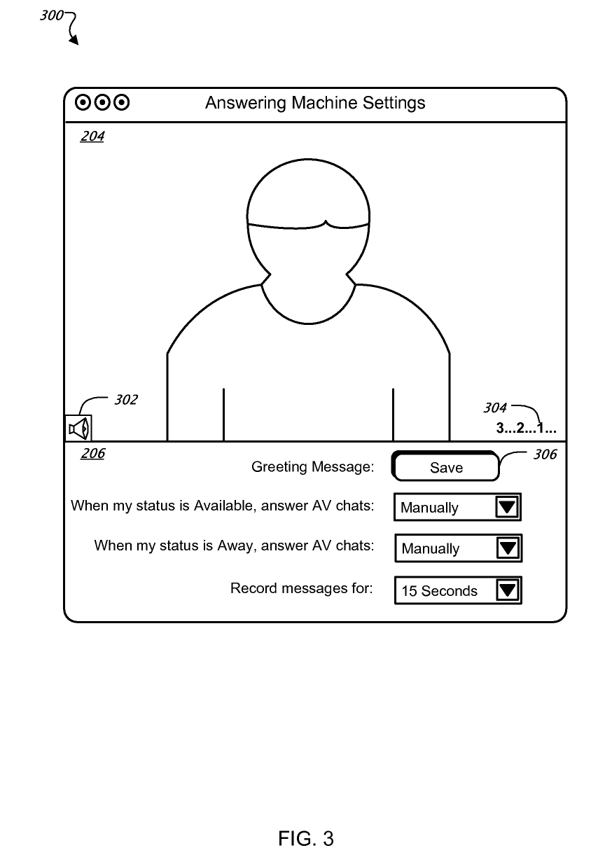

FIG. 3 shows a screen shot depicting an example of a video answering machine settings dialog 300 while an answering machine greeting is being recorded. For example, the user may have pressed the record button 208 (FIG. 2). Within the viewing pane 204, a live video feed of the user is displayed. A sound icon 302 is available to the user to manipulate audio controls (e.g., volume, background music, etc.) associated with the video message. In some implementations, a scrolling countdown 304 prepares the user to begin recording the answering machine greeting. Other countdown mechanisms are also possible, including audible countdowns.

If the user wishes to keep the recorded greeting, selection of a save button 306 will store the message. Selection of the save button 306 can, for example, store the message within the active greeting location. In some implementations, the active greeting location is on a video chat server connected to the network connection 108. In other implementations, the active greeting location is within local or external storage connected to the computer 102. In other implementations, the user has control over where the greeting is stored. In some implementations, the user is also provided with a cancel mechanism such as a cancel button. The user can preview the greeting, in some implementations, before choosing to save the greeting. Upon selection of the save button 306, in some implementations, the user is prompted for additional information. For example, the user can be given the choice of replacing a presently active greeting with the new greeting.

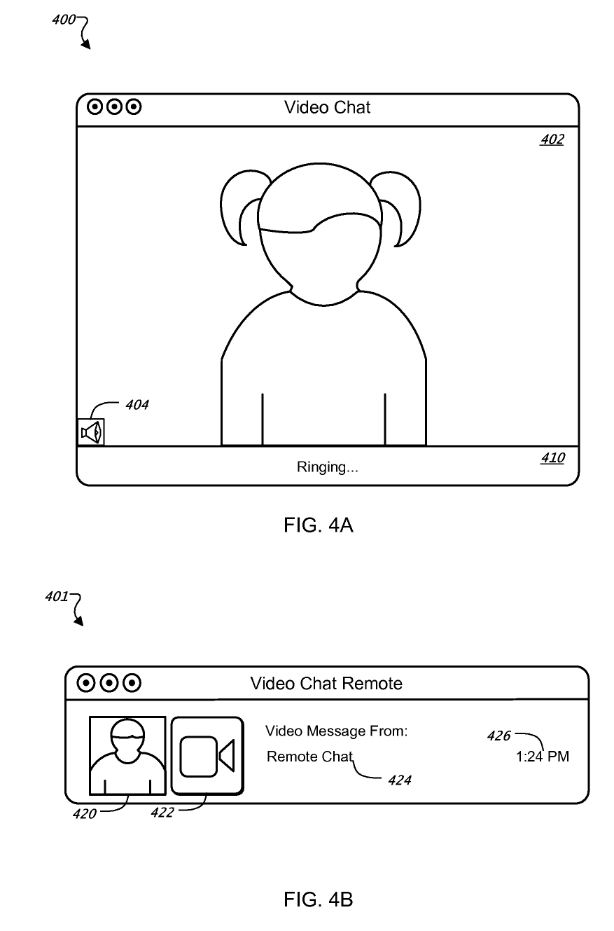

FIG. 4A is a screen shot depicting an example of a dialog 400 for video chat communication. In the example shown, a viewing pane 402 contains an active video presentation of the user, for example the caller 107. A sound icon 404 is available to the user to manipulate audio controls (e.g., volume, mute, etc.) associated with the video feed. The dialog 400 for video chat communication can be launched, for example, after the user selects a call option in a video messaging application GUI. A status bar 410 alerts the user to the status of the call. In the example shown, the current message within the status bar 410 is “ringing.” In some implementations, the dialog 400 is associated with a particular end user. For example, the dialog 400 can have been launched from a video messaging application GUI friends list. In other implementations, when selecting a call option, the user can also select the recipient of the video chat request.

FIG. 4B is a screen shot depicting an example of a video message alert 401. The video message alert 401 can provide the user access to a stored video message. In the example shown, the video message within video message alert 401 was received from the call recipient in response to the video chat request depicted in dialog 400. In various implementations, a video message can be sent without the need to initiate a video chat session. For example, a caller can send a holiday greeting within a video message to a user's video mailbox.

The video message alert 401 can include a picture 420 associated with the sender. In some implementations, the picture 420 is a still image of a video frame of the video message (e.g., the first frame, an end frame, or another frame selected from among the video frames of the message). In other implementations, the picture 420 can be an icon associated with a person within the receiver's address list or an icon that the sender attaches with the video message.

Next to the picture 420 is a video button 422. In some implementations, metadata associated with the video message can be viewed by a right click or a mouse-over of the video button 422. In this example, metadata can include the video size, the date the video was created, the file type, etc. The metadata can be displayed, for example, as an overlay over the video message alert 401. Selection of the video button 422 launches the video message. In some implementations, the video is stored in external or local storage attached to the call recipient's device, for example, the computer 102 (FIG. 1). In other implementations, the video is stored within a video chat server attached to the network connection 108. In this example, activation of the video button 422 initiates the download of the video message. In some implementations, when the video message is launched by selecting the video button 422, the video chat component 117 opens a video message viewing dialog. One option within the video message viewing dialog, in some implementations, can be to respond to the video message.

A signature line 424 provides the user with the name of the sender (e.g., the caller). The signature line 424 can include, but is not limited to, a name, the name of the sending electronic device, and/or the sending location IP address. A timestamp 426 informs the user of when the video message was received.

In some implementations, the video chat component 117 provides default video messages. For example, video presentations similar to electronic greeting cards can be available for selection in various themes (e.g., happy birthday, thank you, miss you, etc). In addition, previously recorded user videos can be sent as video messages and video message responses using the video chat component 117. When sending a video message, in some implementations, the sender can select multiple recipients. For example, a user can create a party invitation video message and send the video message to each invitee.

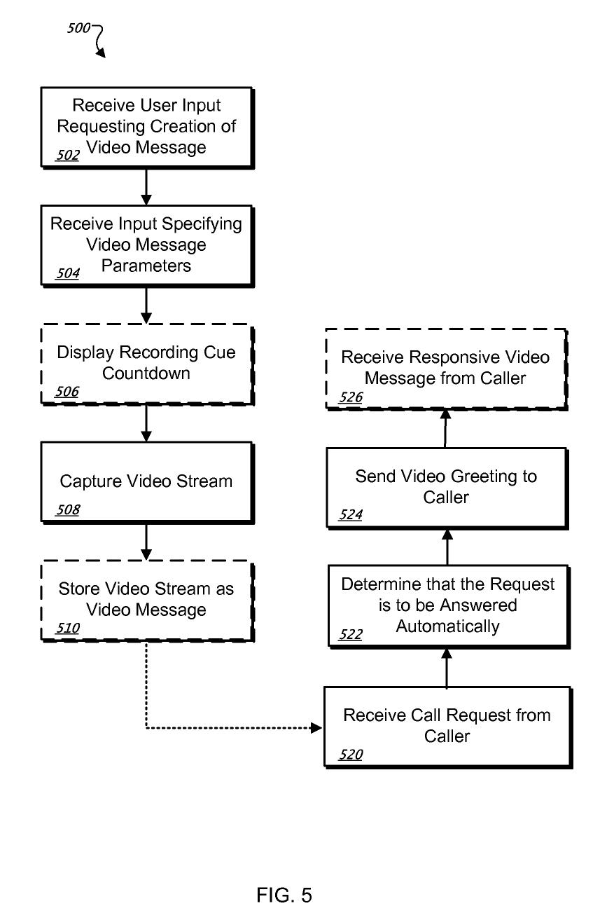

FIG. 5 is a flow diagram of an example method 500 for recording a video answering machine message. The method 500 can be performed using the video chat component 117 (FIG. 1), for example. Step 502 receives a user input requesting the creation of a video answering machine message. The video answering machine message creation, for example, can be initiated through the answering machine settings dialog 200 (FIG. 2). In some implementations, the video message is used as a video greeting to be sent in response to a caller trying to initiate a video chat. Alternatively, the method 500 (e.g., by steps 502-508) can be used to record a video message that is responsive to a video greeting.

In step 504, video greeting parameters are specified. In one example, the user can specify the length of the video greeting. The user can also specify when a video greeting is to be used. For example, the user can specify that the video answering machine message be sent in response to a video chat request when the user's status is away or idle or when the user has not responded to the chat request within 60 seconds of receiving it. In some implementations, the user specifies which callers can receive the message. For example, the user can specify that the video answering machine message be sent only if the caller is within the user's address list.

Optionally, at step 506, a recording cue countdown can be displayed to the user. The recording cue countdown, such as the scrolling countdown 304 (FIG. 3), prepares the user to begin recording the video message. During the time of the countdown, for example, the user can adjust the camera so that the image is centered properly.

The video stream is captured at step 508. If the user specified a message length at step 504, the video is captured for the set length of time. In another example, the video stream capture can end when the user activates a stop mechanism. In some implementations, the message is captured to a temporary storage location. The temporary message, in various implementations, can then be previewed before saving. In some implementations, the user can cancel recording of the video message and end method 500.

The video stream is stored as a video message at step 510. In addition to video data, a video message can contain, in some implementations, information regarding the user and the message content. At least some of this information can be in the form of metadata. For example, the message can contain the user's name or other identification (e.g., chat nickname, IP address, email address, etc.), video length, security information, photo, and/or personal graphic (e.g., avatar). In some implementations, the message is stored locally. For example, if the message is created on computer 102 (FIG. 1), the message can be stored within the local storage 106 or within other internal or external storage connected to computer 102. In some implementations, the message is stored within a video chat network server. For example, a video chat server connected to network connection 108 can store the recorded message. In this example, the recorded message can be provided in response to a video chat request even if the user is not connected to the video chat application and/or the network connection 108 at the time of the request.

Subsequently, the message can be used as a message greeting to respond to a caller's video chat request. For example, a call request is received from a caller at step 520. The call request can be received over the network connection 108 from a caller 107. Step 522 determines that the request is to be automatically answered. This determination is based on the video message parameters. For example, if the parameters specify that the video message should be played if the user is idle, then the determination can include identifying the amount of time elapsed since user input has been received and whether the amount of time exceeds a specified threshold. If, based on the determination, the call request is to be answered automatically, the captured video stream is sent to the calling system as the video greeting in response to the request at step 524. Optionally, a responsive video message can be received from the caller at step 526. The responsive video message can also be created using the method 500 (e.g., by steps 502-508). In some implementations, the length of the responsive video message can be limited by the call recipient, for example, by selecting a record time setting using the drop-down menu 214 of FIG. 2. The responsive video message can be displayed or stored and subsequently played back for the call recipient.

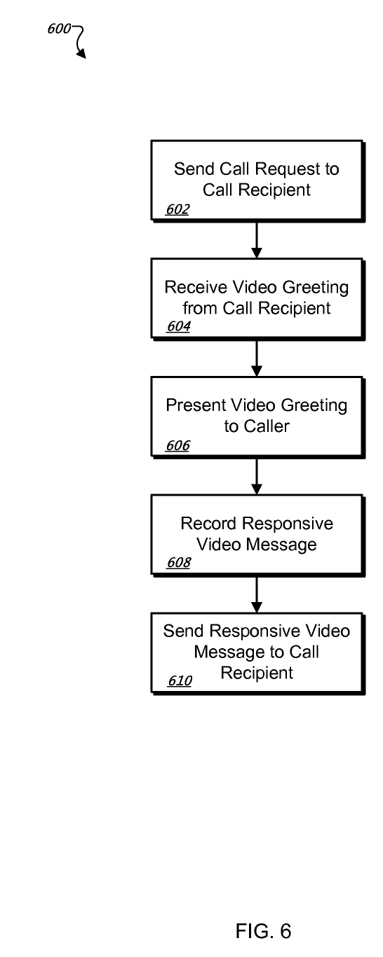

FIG. 6 is a flow diagram of an example method 600 for exchanging video answering machine messages. The method 600 can be performed between the computer 102 and the caller 107 over the network connection 108 (FIG. 1), for example. Step 602 sends a video chat request to a call recipient. For example, a video chat request can be initiated by a user through a video chat application (e.g., video chat client) such as iChat by Apple Inc. of Cupertino, Calif. The video chat request is transferred across a network to the call recipient. The computer 102, for example, can send a video chat request through network connection 108.

At step 604, a video greeting is received in response to the request from the video chat system operated by the call recipient. For example, the call recipient can send a video message as the video greeting over the network connection 108 to the computer 102 operated by the caller. The video greeting, in some implementations, can be a pre-recorded video message and sent automatically by the call recipient. For example, a call recipient can select to have a video message sent automatically whenever a call request is declined or automatically answered with the greeting. In some implementations, the video greeting is stored on a video chat server connected to a network, such as network connection 108. In this example, the video chat server can send the video greeting to the caller even when the call recipient is unavailable. A greeting indicator, in some implementations, alerts the caller that a video greeting has been received and can be reviewed.

The video greeting is presented to the caller at step 606. In some implementations, the video greeting automatically plays for the caller. For example, the video greeting can be presented within the video chat application interface where the caller has attempted to initiate the chat session. In various implementations, only an alert icon is presented to the caller. In this case, the caller can activate the presentation of the video greeting by providing user input (e.g., by clicking on the alert icon). In some implementations, when the caller activates the presentation of the video greeting, the video greeting is downloaded from a video chat server connected to a network such as network connection 108.

At step 608, a video message is recorded or retrieved as a responsive video message. In some implementations, within the presentation of the video greeting, an option can exist to respond to the recording. For example, a button or a menu option can allow the user to reply to the sender. In other implementations, the caller initiates a new message creation dialog, for example, to generate a responsive message. In some implementations, a voice or text message can be sent in response rather than relaying a video message.

The responsive message is sent to the call recipient at step 610. For example, the message is transferred across the network connection 108 to the call recipient. In some implementations, the caller can stream the responsive message to the call recipient as the responsive message is being generated, without needing to store (e.g., locally or remotely) the responsive message. In some implementations, the call recipient does not have to be connected to the network connection 108 at the time the response is sent. In this example, a video chat server connected to network connection 108 can store the responsive video message for the call recipient. The next time the call recipient connects to the video chat server, the responsive video message can be delivered to the call recipient.

In the above description, for purposes of explanation, numerous specific details are set forth in order to provide a thorough understanding. It will be apparent, however, to one skilled in the art that implementations can be practiced without these specific details. In other instances, structures and devices are shown in block diagram form in order to avoid obscuring the disclosure.

In particular, one skilled in the art will recognize that other architectures and graphics environments can be used, and that the examples can be implemented using graphics tools and products other than those described above. In particular, the client/server approach is merely one example of an architecture for providing the functionality described herein; one skilled in the art will recognize that other, non-client/server approaches can also be used. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus for performing the operations herein can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it can prove convenient to construct more specialized apparatuses to perform the method steps. The required structure for a variety of these systems will appear from the description. In addition, the present examples are not described with reference to any particular programming language. It will be appreciated that a variety of programming languages can be used to implement the teachings as described herein. Furthermore, as will be apparent to one of ordinary skill in the relevant art, the modules, features, attributes, methodologies, and other aspects can be implemented as software, hardware, firmware or any combination of the three. Of course, wherever a component is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present description is in no way limited to implementation in any specific operating system or environment.

The subject matter described in this specification can be implemented as one or more computer program products, i.e., one or more modules of computer program instructions encoded on a computer readable medium for execution by, or to control the operation of, data processing apparatus. The instructions can be organized into modules (or engines) in different numbers and combinations from the exemplary modules described. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A method comprising:
receiving a video chat request from a caller; and
providing a video message in response to the video chat request, the video message being operable for playback.

2. The method of claim 1, further comprising:
receiving from the caller a responsive video message, the responsive video message being operable for playback; and
storing the responsive video message.

3. The method of claim 2, further comprising:
providing a user interface for playing the responsive video message; and
indicating, in the user interface, that the responsive video message has been received.

4. The method of claim 1, further comprising:
recording the video message.

5. The method of claim 1, further comprising:
providing in a user interface an indication that the video chat request has been received; and
providing the video message in response to the video chat request after a period of time has elapsed since receiving the video chat request.

6. The method of claim 1, further comprising:
providing the video message when no user input has been received for a period of time exceeding a threshold.

7. The method of claim 1, further comprising:
receiving user input selecting a value of a status indicator; and
providing the video message when the value of the status indicator indicates a do-not-disturb status.

8. A method comprising:
sending a request for a video chat to a call recipient;
receiving, in response to the request, a video message; and
presenting the video message.

9. The method of claim 8, further comprising:
recording a responsive video message; and
sending the responsive video message to the call recipient.

10. A computer-readable medium having instructions stored thereon, which, when executed by a processor, causes the processor to perform operations comprising:
receiving a video chat request from a caller; and
providing a video message in response to the video chat request, the video message being operable for playback.

11. The computer-readable medium of claim 10, where the instructions cause the processor to perform operations further comprising:
receiving from the caller a responsive video message, the responsive video message being operable for playback; and
storing the responsive video message.

12. The computer-readable medium of claim 11, where the instructions cause the processor to perform operations further comprising:
providing a user interface for playing the responsive video message; and
indicating, in the user interface, that the responsive video message has been received.

13. The computer-readable medium of claim 10, where the instructions cause the processor to perform operations further comprising:
recording the video message.

14. The computer-readable medium of claim 10, where the instructions cause the processor to perform operations further comprising:
providing in a user interface an indication that the video chat request has been received; and
providing the video message in response to the video chat request after a period of time has elapsed since receiving the video chat request.

15. The computer-readable medium of claim 10, where the instructions cause the processor to perform operations further comprising:
providing the video message when no user input has been received for a period of time exceeding a threshold.

16. The computer-readable medium of claim 10, where the instructions cause the processor to perform operations further comprising:
receiving user input selecting a value of a status indicator; and
providing the video message when the value of the status indicator indicates a do-not-disturb status.

17. A computer-readable medium having instructions stored thereon, which, when executed by a processor, causes the processor to perform operations comprising:
sending a request for a video chat to a call recipient;
receiving, in response to the request, a video message; and
presenting the video message.

18. The computer-readable medium of claim 17, where the instructions cause the processor to perform operations further comprising:
recording a responsive video message; and
sending the responsive video message to the call recipient.

19. A system comprising:
means for receiving a video chat request from a caller; and
means for providing a video message in response to the video chat request, the video message being operable for playback.

20. The system of claim 19, further comprising:
means for receiving from the caller a responsive video message, the responsive video message being operable for playback; and
means for storing the responsive video message.

21. The system of claim 20, further comprising:
means for providing a user interface for playing the responsive video message; and
means for indicating, in the user interface, that the responsive video message has been received.

22. The system of claim 19, further comprising:
means for recording the video message.

23. The system of claim 19, further comprising:
means for providing in a user interface an indication that the video chat request has been received; and
means for providing the video message in response to the video chat request after a period of time has elapsed since receiving the video chat request.

24. The system of claim 19, further comprising:
means for providing the video message when no user input has been received for a period of time exceeding a threshold.

25. The system of claim 19, further comprising:
means for receiving user input selecting a value of a status indicator; and
means for providing the video message when the value of the status indicator indicates a do-not-disturb status.
